(19) United States
(12) Patent Application Publication
(10) Pub. No.: US 2022/0078524 A1
(43) Pub. Date: Mar. 10, 2022

(54) METHOD, SYSTEM, AND NON-TRANSITORY COMPUTER-READABLE RECORDING MEDIUM FOR PROVIDING CONTENT COMPRISING AUGMENTED REALITY OBJECT BY USING PLURALITY OF DEVICES

(71) Applicant: 39DEGREES C INC., Seoul (KR)

(72) Inventors: Seung Won WOO, Seoul (KR); Hyun Goo PARK, Seoul (KR)

(73) Assignee: 39DEGREES C INC., Seoul (KR)

(21) Appl. No.: 17/526,204

(22) Filed: Nov. 15, 2021

Related U.S. Application Data
(63) Continuation of application No. PCT/KR2020/006409, filed on May 15, 2020.

(30) Foreign Application Priority Data
May 16, 2019 (KR) 10-2019-0057434

(51) Int. Cl. H04N 21/472; H04N 21/232; G06T 19/00

(52) U.S. Cl. CPC H04N 21/47205; G06T 19/006; H04N 21/232

(57) ABSTRACT

A method for providing a content includes sharing modeling information on an augmented reality (AR) object to be contained in a content between a main device and at least one sub device located around the main device; displaying on the main device a main video in which the object is displayed in a video captured by the main device, and displaying on the at least one sub device at least one sub video in which the object is displayed in at least one video captured by the at least one sub device, with reference to the modeling information and position and posture information of the main device and the at least one sub device; transferring frame data on the at least one sub video to the main device; and causing at least one of the main video and the at least one sub video to be contained in the content.

### CROSS-REFERENCE TO RELATED APPLICATION(S)

This application is a continuation application of Patent Cooperation Treaty (PCT) International Application No. PCT/KR2020/006409 filed on May 15, 2020, which claims priority to Korean Patent Application No. 10-2019-0057434 filed on May 16, 2019. The entire contents of PCT International Application No. PCT/KR2020/006409 and Korean Patent Application No. 10-2019-0057434 are hereby incorporated by reference.

### FIELD OF THE INVENTION

The present invention relates to a method, system, and non-transitory computer-readable recording medium for providing a content containing an augmented reality (AR) object using a plurality of devices.

### BACKGROUND

In recent years, platforms where people watch videos are changing from television to mobile platforms with the development of network environments and mobile devices, and many video platforms such as YouTube, Twitch, and Afreeca TV provide live channels where anyone can broadcast. Accordingly, broadcasting entities are also changing from broadcasting stations to ordinary individuals such as creators or influencers.

However, according to the techniques introduced so far, it is possible to operate a content provision service such as broadcasting only by using separate broadcasting equipment, in spite of the above changes in broadcasting environments.

Meanwhile, services for providing contents using augmented reality are increasing due to the development of technology. However, according to the techniques introduced so far, it is difficult to effectively provide such services due to the absence of platforms where users can specially produce the contents using augmented reality.

### SUMMARY OF THE INVENTION

One object of the present invention is to solve all the above-described problems in prior art.

Another object of the invention is to provide a content containing an augmented reality (AR) object using a plurality of devices, by sharing modeling information on an AR object to be contained in a content between a main device and at least one sub device located around the main device, when the modeling information is generated; displaying on the main device a main video in which the AR object is displayed in a video captured by the main device, with reference to the modeling information and position information and posture information of the main device, and displaying on the at least one sub device at least one sub video in which the AR object is displayed in at least one video captured by the at least one sub device, with reference to the modeling information and position information and posture information of the at least one sub device; transferring frame data related to the at least one sub video to the main device; and causing at least one of the main video and the at least one sub video to be contained in the content, according to a user command inputted through the main device.

The representative configurations of the invention to achieve the above objects are described below.

According to one aspect of the invention, there is provided a method for providing a content containing an augmented reality (AR) object using a plurality of devices, the method comprising the steps of: sharing modeling information on an AR object to be contained in a content between a main device and at least one sub device located around the main device, when the modeling information is generated; displaying on the main device a main video in which the AR object is displayed in a video captured by the main device, with reference to the modeling information and position information and posture information of the main device, and displaying on the at least one sub device at least one sub video in which the AR object is displayed in at least one video captured by the at least one sub device, with reference to the modeling information and position information and posture information of the at least one sub device; transferring frame data related to the at least one sub video to the main device; and causing at least one of the main video and the at least one sub video to be contained in the content, according to a user command inputted through the main device.

According to another aspect of the invention, there is provided a system for providing a content containing an augmented reality (AR) object using a plurality of devices, the system comprising: a modeling information sharing unit configured to share modeling information on an AR object to be contained in a content between a main device and at least one sub device located around the main device, when the modeling information is generated; a video display unit configured to display on the main device a main video in which the AR object is displayed in a video captured by the main device, with reference to the modeling information and position information and posture information of the main device, and to display on the at least one sub device at least one sub video in which the AR object is displayed in at least one video captured by the at least one sub device, with reference to the modeling information and position information and posture information of the at least one sub device; a data transfer unit configured to transfer frame data related to the at least one sub video to the main device; and a content management unit configured to cause at least one of the main video and the at least one sub video to be contained in the content, according to a user command inputted through the main device.

In addition, there are further provided other methods and systems to implement the invention, as well as non-transitory computer-readable recording media having stored thereon computer programs for executing the methods.

According to the invention, it is possible to provide a content using an augmented reality object using only a plurality of mobile devices without separate broadcasting equipment, so that anyone can provide a service using the augmented reality content.

According to the present invention, it is possible to produce augmented reality contents that can be utilized for education, advertisement production, live broadcasting, corporate marketing, conferences, lectures, and the like by various producing methods without using separate equipment, so that costs can be reduced.

### BRIEF DESCRIPTION OF THE DRAWINGS

FIG. 1 schematically shows the configuration of an entire system for providing a content containing an augmented reality (AR) object according to one embodiment of the invention.

FIG. 2 specifically shows the internal configuration of a content provision system according to one embodiment of the invention.

FIG. 3 illustratively shows a situation in which an AR object to be contained in a content is displayed in a video captured by a main device according to one embodiment of the invention.

FIG. 4 illustratively shows a situation in which a content containing an AR object is captured by a plurality of devices according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each of the embodiments may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

Configuration of an Entire System

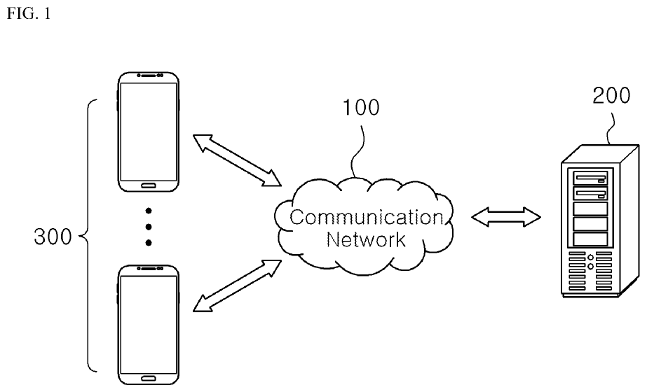

FIG. 1 schematically shows the configuration of an entire system for providing a content containing an augmented reality (AR) object according to one embodiment of the invention.

As shown in FIG. 1, the entire system according to one embodiment of the invention may comprise a communication network 100, a content provision system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the content provision system 200 according to one embodiment of the invention may function to: share modeling information on an AR object to be contained in a content between a main device and at least one sub device located around the main device, when the modeling information is generated; display on the main device a main video in which the AR object is displayed in a video captured by the main device, with reference to the modeling information and position information and posture information of the main device, and display on the at least one sub device at least one sub video in which the AR object is displayed in at least one video captured by the at least one sub device, with reference to the modeling information and position information and posture information of the at least one sub device; transfer frame data related to the at least one sub video to the main device; and cause at least one of the main video and the at least one sub video to be contained in the content, according to a user command inputted through the main device.

The configuration and functions of the content provision system 200 according to the invention will be discussed in detail in the following description.

Next, the device 300 according to one embodiment of the invention is digital equipment capable of connecting to and then communicating with the content provision system 200, and any type of digital equipment having at least one of a video capture module and a memory means and a microprocessor for computing capabilities, such as smart phones, tablets, smart watches, smart bands, smart glasses, desktop computers, notebook computers, workstations, personal digital assistants (PDAs), web pads, and mobile phones, may be adopted as the device 300 according to the invention. Further, it is noted that the device 300 encompasses a main device, a sub device, and a viewer device described herein.

Particularly, the device 300 may include an application (not shown) for supporting production or reception of a service such as relay broadcasting from the content provision system 200. The application may be downloaded from the content provision system 200 or a known web server (not shown).

Configuration of the Content Provision System

Hereinafter, the internal configuration of the content provision system 200 crucial for implementing the invention and the functions of the respective components thereof will be discussed.

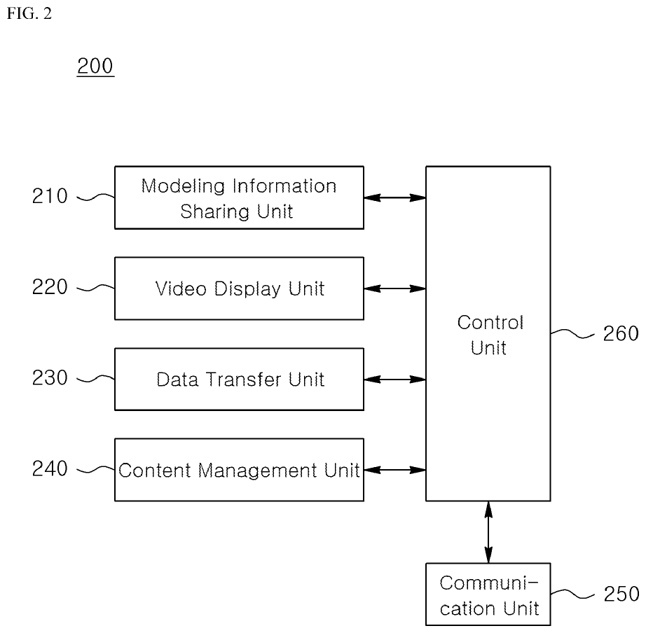

FIG. 2 specifically shows the internal configuration of the content provision system 200 according to one embodiment of the invention.

As shown in FIG. 2, the content provision system 200 according to one embodiment of the invention may comprise a modeling information sharing unit 210, a video display unit 220, a data transfer unit 230, a content management unit 240, a communication unit 250, and a control unit 260. According to one embodiment of the invention, at least some of the modeling information sharing unit 210, the video display unit 220, the data transfer unit 230, the content management unit 240, the communication unit 250, and the control unit 260 may be program modules to communicate with an external system. The program modules may be included in the content provision system 200 in the form of operating systems, application program modules, and other program modules, while they may be physically stored in a variety of commonly known storage devices. Further, the program modules may also be stored in a remote storage device that may communicate with the content provision system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the content provision system 200 has been described as above, and it will be apparent to those skilled in the art that at least a part of the components or functions of the content provision system 200 may be implemented or included in an external system (not shown), as necessary.

First, according to one embodiment of the invention, the modeling information sharing unit 210 may function to share modeling information on an augmented reality (AR) object to be contained in a content between a main device and at least one sub device located around the main device, when the modeling information is generated.

Specifically, the modeling information sharing unit 210 according to one embodiment of the invention may share the generated modeling information between the main device and the at least one sub device located around the main device. Such sharing may be directly carried out between the main device and the at least one sub device using known communication techniques such as Wi-Fi Direct and Bluetooth, and may also be indirectly carried out using mobile communication techniques such as LTE and 5G, and an external system (not shown) or an application (not shown). Meanwhile, the modeling information according to one embodiment of the invention may include, but is not limited to, three-dimensional (3D) image information on the AR object to be contained in the content (e.g., information on the AR object itself, information on how the AR object is displayed on the main device, and the like) and information on a space where the AR object is to be displayed (e.g., a position where the AR object is to be displayed, information on an object related to the displaying of the AR object, and the like).

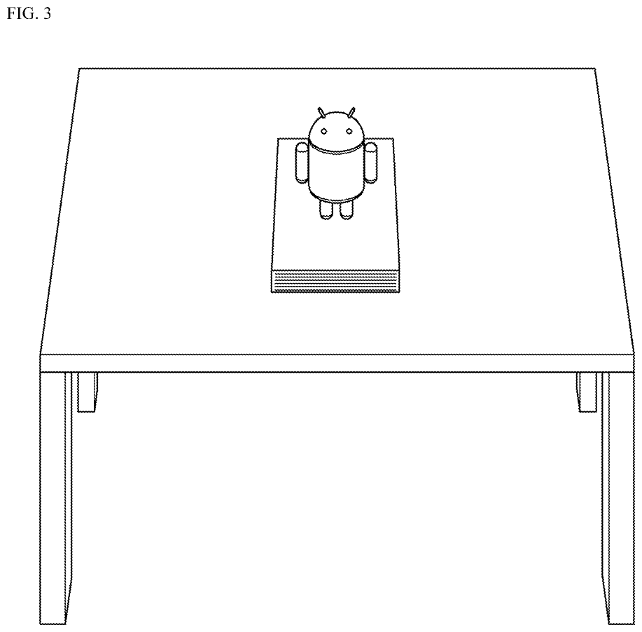

FIG. 3 illustratively shows a situation in which an AR object to be contained in a content is displayed in a video captured by the main device according to one embodiment of the invention.

For example, referring to FIG. 3, when an AR object to be contained in a content is determined (i.e., an Android doll), and it is determined that a specific side of the AR object (i.e., a front side of the Android doll) is to be displayed on the main device and the AR object is to be displayed in a specific position on a specific object located in a specific space (i.e., a central position on a book placed on a desk), the modeling information sharing unit 210 according to one embodiment of the invention may function to share the modeling information as above between the main device and the at least one sub device located around the main device.

Meanwhile, according to one embodiment of the invention, although modeling information on an AR object to be contained in a content may be provided by the content providing system 200, modeling information on an AR object desired by a user who produces a content using the main device and the at least one sub device located around the main device may also be contained in the content.

For example, according to one embodiment of the invention, a user who produces a content using the main device and the at least one sub device located around the main device may select modeling information on an AR object provided by the content provision system 200 and cause the modeling information to be contained in the content, but may also cause modeling information on an AR object personally generated by the user (e.g., a 3D brand character) to be contained in the content.

Further, when the AR object is manipulated by a user of the main device or a user of the at least one sub device located around the main device, the modeling information sharing unit 210 according to one embodiment of the invention may function to share the modeling information in which a result of the manipulation is reflected between the main device and the at least one sub device.

Specifically, according to one embodiment of the invention, the user of the main device or the at least one sub device located around the main device may manipulate the AR object by means of touches, drags, or the like on a display of the device, and such manipulation may include actions such as adjusting a size or position of the AR object, controlling an operation of the AR object, and rotating the AR object. In addition, the modeling information sharing unit 210 according to one embodiment of the invention may function to share the modeling information in which a result of the user's manipulation of the AR object is reflected between the main device and the at least one sub device.

For example, when the manipulation of the user of the main device causes the AR object to be moved to a rightward position by a predetermined distance and rotated by 180 degrees to make changes such that an opposite side of the originally displayed side is displayed on the main device, the modeling information sharing unit 210 according to one embodiment of the invention may function to share the modeling information on the AR object that is moved to the rightward position by the predetermined distance and rotated by 180 degrees between the main device and the at least one sub device located around the main device.

Next, the video display unit 220 according to one embodiment of the invention may function to display on the main device a main video in which the AR object to be contained in the content is displayed in a video captured by the main device, with reference to the modeling information on the AR object and position information and posture information of the main device, and to display on the at least one sub device located around the main device at least one sub video in which the AR object is displayed in at least one video captured by the at least one sub device, with reference to the modeling information and position information and posture information of the at least one sub device.

Specifically, the video display unit 220 according to one embodiment of the invention may function to cause the AR object to be contained in the content to be displayed in a video captured by the main device, and cause the main device to display a main video in which the AR object is displayed in the video captured by the main device, with reference to the modeling information on the AR object, a capture position of the main device included in the position information of the main device, and a capture angle and a capture direction of the main device included in the posture information of the main device.

Further, the video display unit 220 according to one embodiment of the invention may function to cause the AR object to be contained in the content to be displayed in at least one video captured by the at least one sub device located around the main device, and cause the at least one sub device to display at least one sub video in which the AR object is displayed in the at least one video captured by the at least one sub device, with reference to the modeling information on the AR object, a capture position of the at least one sub device included in the position information of the at least one sub device, and a capture angle and a capture direction of the at least one sub device included in the posture information of the at least one sub device.

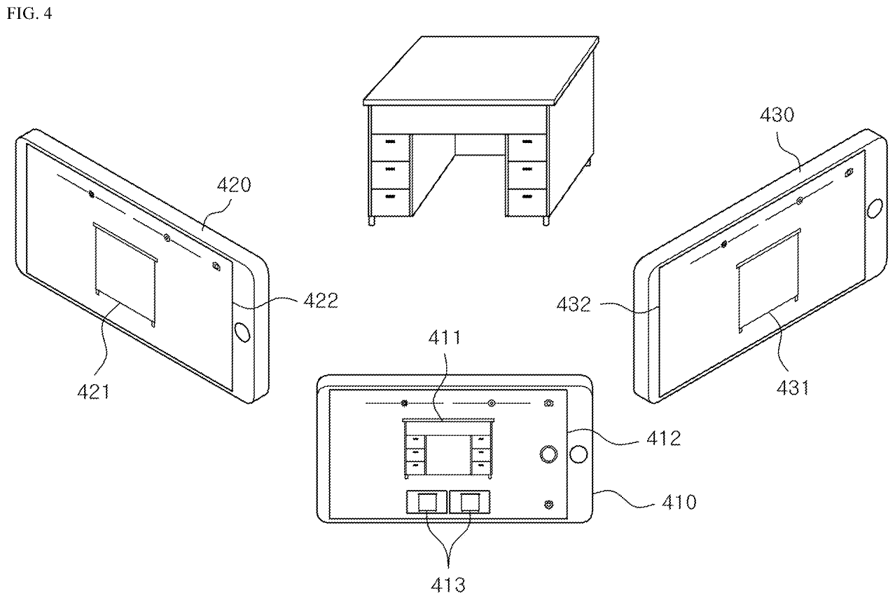

FIG. 4 illustratively shows a situation in which a content containing an AR object is captured by a plurality of devices according to one embodiment of the invention.

For example, referring to FIG. 4, the video display unit 220 according to one embodiment of the invention may function to cause an AR object to be contained in a content (i.e., a desk) to be displayed as 411 in a video captured by a main device 410, and cause the main device 410 to display a main video 412 in which the AR object is displayed as 411 in the video captured by the main device 410, with reference to modeling information on the AR object, a capture position of the main device 410, and a capture angle and a capture direction of the main device 410. Further, the video display unit 220 according to one embodiment of the invention may function to cause the AR object to be contained in the content (i.e., the desk) to be displayed as 421 and 431 in videos captured by sub devices 420 and 430 located around the main device 410, and cause the sub devices 420 and 430 to display sub videos 422 and 432 in which the AR object is displayed as 421 and 431 in the videos captured by the sub devices 420 and 430, with reference to the modeling information on the AR object, capture positions of the sub devices 420 and 430, and capture angles and capture directions of the sub devices 420 and 430.

As another example, when the main device or the at least one sub device located around the main device captures a position other than the position where the AR object is displayed, the video display unit 220 according to one embodiment of the invention may function to display only a part of the AR object, or not display the AR object at all, in the main video or the at least one sub video.

Meanwhile, the video display unit 220 according to one embodiment of the invention may function to display an appearance of the AR object displayed in the at least one sub video differently from an appearance of the AR object displayed in the main video.

Specifically, when a specific side of the AR object is displayed in the main video, the video display unit 220 according to one embodiment of the invention may function to display a side other than the specific side of the AR object in the at least one sub video.

For example, referring to FIG. 4, when a front side 411 of the AR object (i.e., the desk) is displayed in the main video 412, the video display unit 220 according to one embodiment of the invention may display a left side 421 of the desk in the sub video 422 displayed by the sub device 420, which carries out capture on the left of the main device 410, and display a right side 431 of the desk in the sub video 432 displayed by the sub device 430, which carries out capture on the right of the main device 410.

Further, when the AR object is manipulated by the user of the main device or the user of the at least one sub device located around the main device, the video display unit 220 according to one embodiment of the invention may function to display the main video and the at least one sub video in which a result of the manipulation is reflected on the main device and the at least one sub device, respectively.

Specifically, when the AR object is manipulated by the user of the main device or the user of the at least one sub device located around the main device as described above, the video display unit 220 according to one embodiment of the invention may function to display the main video and the at least one sub video in which a result of the manipulation is reflected on the main device and the at least one sub device, respectively, because the modeling information in which the result of the manipulation is reflected is shared between the main device and the at least one sub device, and the video display unit 220 refers to the modeling information.

For example, in a situation in which a front side of an AR object is displayed in a main video, a left side of the AR object is displayed in a first sub video, and a right side of the AR object is displayed in a second sub video, when the AR object is rotated by 180 degrees by manipulation of the user of the main device so that a rear side of the AR object is displayed in the main video, the video display unit 220 according to one embodiment of the invention may make changes to reflect a result of the manipulation so that the right side of the AR object is displayed in the first sub video and the left side of the AR object is displayed in the second sub video, i.e., the AR object in the first and second sub videos is also rotated by 180 degrees.

Next, the data transfer unit 230 according to one embodiment of the invention may function to transfer frame data related to the at least one sub video to the main device.

Specifically, when frames related to the at least one sub video are extracted and compressed images are generated, the data transfer unit 230 according to one embodiment of the invention may function to transfer them to the main device at a predetermined frequency (e.g., 30 frames per second). Such transfer may be directly carried out between the main device and the at least one sub device using known communication techniques such as Wi-Fi Direct and Bluetooth, and may also be indirectly carried out using mobile communication techniques such as LTE and 5G, and an external system (not shown) or an application (not shown).

Next, the content management unit 240 according to one embodiment of the invention may function to cause at least one of the main video and the at least one sub video to be contained in the content, according to a user command inputted through the main device.

Specifically, when a user command is inputted through the main device by means of touches or drags on the display of the main device, voice recognition, or the like, the content management unit 240 according to one embodiment of the invention may function to cause at least one of the main video and the at least one sub video selected by the user command to be contained in the content.

For example, in a situation in which the main video is displayed in a main display area to be described below, when the user issues a command to select at least one of the at least one sub video by means of touches or drags on the display of the main device, voice recognition, or the like, and cause the at least one selected sub video to be displayed in the main display area, the content management unit 240 according to one embodiment of the invention may function to switch the video displayed in the main display area to the at least one selected sub video, and cause the at least one selected sub video to be contained in the content. Meanwhile, the content management unit 240 according to one embodiment of the invention may function to cause the main video, which has been displayed in the main display area before the switch to the at least one sub video, to be displayed in a sub display area to be described below.

Further, the content management unit 240 according to one embodiment of the invention may function to allow the user command inputted through the main device to be inputted through a main display area or at least one sub display area.

Specifically, according to one embodiment of the invention, the main display area refers to an area in which a video contained in a provided content is displayed on the main device, and the at least one sub display area refers to an area in which a video not contained in the provided content is displayed on the main device. Meanwhile, according to one embodiment of the invention, the at least one sub display area may be another area separated from the main display area, or may be a part of the main display area as shown in FIG. 4.

For example, according to one embodiment of the invention, FIG. 4 shows a main display area 412 that is an area in which a video contained in a provided content is displayed on the main device 410, and a sub display area 413 that is a part of the main display area 412 and an area in which a video not contained in the provided content is displayed on the main device 410. Meanwhile, since not only the main video but also the sub video may be displayed in the main display area 412 according to an input of the user of the main device 410 as described above, it should be understood that the main display area 412 and the main video are distinguished from each other. That is, according to one embodiment of the invention, in a situation in which the main video or the at least one sub video is displayed in the main display area 412, when the user of the main device 410 selects at least one video displayed in the sub display area 413, the at least one selected video is displayed in the main display area 412 and the video previously displayed in the main display area 412 is displayed in the sub display area 413.

Meanwhile, according to one embodiment of the invention, the content provided by the content provision system 200 may be a real-time relay broadcast content. For example, a user who produces a real-time relay broadcast using the main device and the at least one sub device located around the main device may select a video to be displayed in the main display area to determine a relay broadcast video to be provided, and a viewer may watch the determined video in real time using a viewer device.

Next, the communication unit 250 according to one embodiment of the invention may function to enable data transmission/reception from/to the modeling information sharing unit 210, the video display unit 220, the data transfer unit 230, and the content management unit 240.

Lastly, the control unit 260 according to one embodiment of the invention may function to control data flow among the modeling information sharing unit 210, the video display unit 220, the data transfer unit 230, the content management unit 240, and the communication unit 250. That is, the control unit 260 according to the invention may control data flow into/out of the content provision system 200 or data flow among the respective components of the content provision system 200, such that the modeling information sharing unit 210, the video display unit 220, the data transfer unit 230, the content management unit 240, and the communication unit 250 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing a content containing an augmented reality (AR) object using a plurality of devices, the method comprising the steps of:
sharing modeling information on an AR object to be contained in a content between a main device and at least one sub device located around the main device, when the modeling information is generated;
displaying on the main device a main video in which the AR object is displayed in a video captured by the main device, with reference to the modeling information and position information and posture information of the main device, and displaying on the at least one sub device at least one sub video in which the AR object is displayed in at least one video captured by the at least one sub device, with reference to the modeling information and position information and posture information of the at least one sub device;
transferring frame data related to the at least one sub video to the main device; and
causing at least one of the main video and the at least one sub video to be contained in the content, according to a user command inputted through the main device.

2. The method of claim 1, wherein the AR object is capable of being manipulated by a user of the main device or a user of the at least one sub device.

3. The method of claim 1, wherein in the causing step, the user command is inputted through a main display area or at least one sub display area.

4. The method of claim 1, wherein in the displaying step, an appearance of the AR object displayed in the at least one sub video is different from an appearance of the AR object displayed in the main video.

5. A non-transitory computer-readable recording medium having stored thereon a computer program for executing the method of claim 1.

6. A system for providing a content containing an augmented reality (AR) object using a plurality of devices, the system comprising:
a modeling information sharing unit configured to share modeling information on an AR object to be contained in a content between a main device and at least one sub device located around the main device, when the modeling information is generated;
a video display unit configured to display on the main device a main video in which the AR object is displayed in a video captured by the main device, with reference to the modeling information and position information and posture information of the main device, and to display on the at least one sub device at least one sub video in which the AR object is displayed in at least one video captured by the at least one sub device, with reference to the modeling information and position information and posture information of the at least one sub device;
a data transfer unit configured to transfer frame data related to the at least one sub video to the main device; and
a content management unit configured to cause at least one of the main video and the at least one sub video to be contained in the content, according to a user command inputted through the main device.
